(19) United States
(12) Patent Application Publication
(10) Pub. No.: US 2014/0132174 A1
(43) Pub. Date: May 15, 2014

(54) PIXEL DRIVER CIRCUITS

(71) Applicant: Euan Smith, Campbridgeshire (GB)

(72) Inventor: Euan Smith, Campbridgeshire (GB)

(21) Appl. No.: 14/234,965

(22) PCT Filed: Aug. 2, 2012
(86) PCT No.: PCT/GB2012/000630

§ 371 Date: Jan. 24, 2014

(30) Foreign Application Priority Data
Aug. 24, 2011 (GB) 1114651.1

(51) Int. Cl. G09G 3/32

(52) U.S. Cl. CPC G09G 3/3225
USPC 315/224

(57) ABSTRACT

An active matrix OLED pixel driver circuit comprises: a power supply connection to receive a power supply; an OLED drive connection to drive an OLED; an OLED drive transistor having an input, output and control connection, wherein said input connection is coupled to said power supply connection and said output connection is coupled to said OLED drive connection; a gate capacitor having a first plate coupled to said control connection of said OLED drive transistor and a second plate coupled to a common capacitor connection; a first select transistor having an input connection, an output connection coupled to said first plate of said gate capacitor, and a control connection coupled to a first pixel select connection of said OLED pixel driver circuit; an input capacitor having a first plate coupled to said input connection of said first select transistor and a second plate coupled to said common capacitor connection; and a second select transistor having an input connection, an output connection coupled to said first plate of said input capacitor, and a control connection coupled to a second pixel select connection of said OLED pixel driver circuit.

### FIELD OF THE INVENTION

This invention relates to improved pixel driver circuits and techniques for active matrix organic light emitting diode (OLED) displays.

### BACKGROUND TO THE INVENTION

It is known to drive an OLED display using an ‘active matrix’ arrangement in which individual pixels of the display are activated by an associated thin film transistor. (In this specification, where in this specification, references to pixels of an OLED display should be interpreted as also covering sub-pixels of a multicolour OLED display, typically constructed using groups of red, green and blue-emitting sub-pixels).

In one drive technique an analogue current is employed to program the drive current of an active matrix OLED pixel so that the current through the pixel, and hence the luminance, is proportional to the programmed level. In another approach a pixel is voltage-programmed and the pixel luminance is determined by a programming voltage applied to the active matrix (AM) pixel.

Whether a pixel is current programmed or voltage programmed, an active matrix pixel comprises a memory element, typically a storage capacitor, coupled to an OLED drive transistor.

It is generally desirable to reduce the area of the memory element (storage capacitance), but it is also desirable to maintain a long pixel ‘memory’ (programmed luminance hold time) especially as the number of pixels in a display grows larger.

### SUMMARY OF THE INVENTION

According to a first aspect of the invention there is therefore provided an active matrix OLED pixel driver circuit, the circuit comprising: a power supply connection to receive a power supply;
an OLED drive connection to drive an OLED; an OLED drive transistor having an input, output and control connection, wherein said input connection is coupled to said power supply connection and said output connection is coupled to said OLED drive connection; a gate capacitor having a first plate coupled to said control connection of said OLED drive transistor and a second plate coupled to a common capacitor connection; a first select transistor having an input connection, an output connection coupled to said first plate of said gate capacitor, and a control connection coupled to a first pixel select connection of said OLED pixel driver circuit;
an input capacitor having a first plate coupled to said input connection of said first select transistor and a second plate coupled to said common capacitor connection; and a second select transistor having an input connection, an output connection coupled to said first plate of said input capacitor, and a control connection coupled to a second pixel select connection is a said OLED pixel driver circuit.

In embodiments by doubling up the number of capacitors, and sharing the storage capacitance amongst these, the total area of the storage capacitance (summing that of the gate capacitor and input capacitor) may be reduced. This may be achieved whilst maintaining the hold time of the active matrix pixel circuit and, simultaneously, maintaining or reducing the programming time of the circuit. This is counter-intuitive because normally one would expect both the hold time and the programming time to be proportional to the capacitance, and that therefore increasing one should increase the other. In embodiments of the pixel driver circuits we describe, the programming time may be reduced without substantially affecting the hold time for the same overall area of storage capacitance.

In embodiments, each of the pixel select connections is coupled to a shared pixel select connection of the pixel driver circuit, although this is not essential as ‘ganged’ control of two (or more) pixel select connections may be employed. Similarly, in embodiments of one type of pixel driver circuit the common capacitor connection is coupled to the power supply connection for the pixel driver circuit. However in other embodiments of the same type of pixel driver circuit the common capacitor connection may be brought out on a separate line (shared between multiple pixel driver circuits).

The above described techniques may be employed for programming and storing the gate voltage on the OLED drive transistor in either a current-programmed or a voltage-programmed active matrix pixel driver circuit, that is in a circuit in which the drive transistor gate voltage/pixel luminance is programmed by either a current or a voltage on a programming connection to the OLED pixel driver circuit.

Depending upon the implementation of the pixel drive circuit the programming signal (voltage or current) is not necessarily applied to the input connection of the second select transistor. In one arrangement a programming voltage or current is applied directly to the input connection of the second select transistor. In a variant of this, the programming voltage or current is applied to the input connection of the second select transistor via a further select transistor (controlled by the same or a different pixel select connection of the OLED pixel driver circuit).

In other arrangements, however, and in particular in other current-programmed arrangements, the input connection of the second select transistor is coupled to a power supply connection to the pixel driver circuit. Then a third-select transistor may be employed, coupled between a current programming line of the circuit and the common capacitor connection. This third select transistor also has a control connection coupled to the same or a different pixel select connection of the pixel driver circuit. In this way, broadly speaking the second select transistor may operate to diode-connect the OLED drive transistor, the programming current then being supplied to the circuit (from a current-programming line) via the third select transistor. In embodiments of this circuit the common capacitor connection may then be coupled to the OLED drive connection of the circuit.

In embodiments of the above described circuits, whether current or voltage programmed, a source connection of the OLED drive FET (field effect transistor) is coupled to the common capacitor connection. This may be a local connection within the pixel driver circuit, or may be a connection made elsewhere on the display, or such a connection may be made off-display.

In some embodiments of the circuit the gate capacitor and input capacitor have substantially the same capacitance value. However this is not essential and, in embodiments, it may be desirable to increase the capacitance of the input capacitor and decrease that of the gate capacitor to change from a 50:50 ratio to a ratio of greater than 60:40, 70:30, 80:20 or 90:10. In practice an optimum ratio may be determined by Experiment—with a low gate capacitance, parasitic capacitance in the circuit will cause coupling of voltage changes onto the gate of the drive transistor. This is undesirable especially where, as in many applications, accurate pixel luminance values are important. Conveniently, in embodiments, the gate capacitor is integrated with the OLED drive transistor by extending a region of gate-source overlap in the drive transistor.

The above described techniques may be extended by incorporating a further select transistor having input/output connections coupled between the output connection of the second select transistor and the input connection of the first select transistor, with a control connection coupled to the or a pixel select connection of the circuit. Then a further capacitor is coupled between the input connection of the first select transistor and the common capacitor connection. In this way the above described approach is extended to three select transistor-storage capacitor stages. However in practice there are likely to be diminishing returns from increasing the number of stages beyond two.

In a related aspect the invention provides a method of driving a pixel of an active matrix OLED display, using a pixel driver circuit comprising: a power supply connection to receive a power supply; an OLED drive connection to drive an OLED; an OLED drive transistor having an input, output and control connection, wherein said input connection is coupled to said power supply connection and said output connection is coupled to said OLED drive connection; the method comprising: programming a control voltage on said control connection of said OLED drive transistor via a chain of transistor-capacitor circuit sections, each said circuit section comprising a select transistor having an output coupled to a capacitor, a final said select transistor of said chain having said output of said select transistor coupled to said control connection of said OLED drive transistor, each of said select transistors having a control connection coupled to a pixel select line of said display and each capacitor of said chain having one plate coupled to a common capacitor connection for said chain; said programming comprising: controlling each of said select transistors to switch on to charge each of said capacitors responsive to a programming signal applied to said chain of transistor-capacitor circuit sections, to charge a final capacitor of said chain to apply said control voltage to said OLED drive transistor; and controlling all of said select transistors to switch off to maintain said control voltage on said control connection of said OLED drive transistor.

As previously described, in embodiments the programming signal need not necessarily be applied to an input connection of a first transistor of a first transistor-capacitor circuit section (i.e. the circuit section furthest from the gate of the drive transistor). Instead, in some arrangements, the programming signal may be applied via an additional select transistor coupled directly to the capacitor of the first transistor-capacitor circuit section of the chain.

In a related aspect the invention provides an active matrix OLED pixel driver circuit, the circuit comprising: a power supply connection to receive a power supply; an OLED drive connection to drive an OLED; an OLED drive transistor having an input, output and control connection, wherein said input connection is coupled to said power supply connection and said output connection is coupled to said OLED drive connection; and
a programming circuit for programming a control voltage on said control connection of said OLED drive transistor, said programming circuit comprising a chain of transistor-capacitor circuit sections, each said circuit section comprising a select transistor having an output coupled to a capacitor, a final said select transistor of said chain having said output of said select transistor coupled to said control connection of said OLED drive transistor, each of said select transistors having a control connection coupled to a pixel select line of said display and each capacitor of said chain having one plate coupled to a common capacitor connection for said chain.

The invention also provides an active matrix OLED display incorporating the above described techniques. The display may comprises a display panel bearing an array of pixel driver circuits, each as described above, fabricated from thin film transistors (TFT's) in amorphous silicon.

### BRIEF DESCRIPTION OF THE DRAWINGS

These and other aspects of the invention will now be described, by way of example only, with reference to the accompanying Figures in which:

FIG. 1 shows an active matrix OLED (AMOLED) pixel driver circuit with a double select switch;

FIG. 2 shows an active matrix (AMOLED) pixel driver circuit with two cascaded capacitors according to an embodiment of the invention;

FIGS. 3a and 3b show simulations of the performance of a circuits of FIGS. 1 and 2 showing, respectively, the time for the gate voltage of the drive transistor to fall by 10%, and the programming time to reach 90% of a desired gate voltage;

FIGS. 4a to 4d illustrate active matrix OLED pixel driver circuits in which the techniques we describe may be employed;

FIGS. 5a to 5c illustrate embodiments of AMOLED pixel driver circuits according to the invention; and

FIG. 6 illustrates an AMOLED display incorporating pixel driver circuits according to an embodiment of the invention.

### DETAILED DESCRIPTION OF PREFERRED EMBODIMENTS

An AMOLED pixel circuit has at minimum a drive transistor which supplies the OLED current, a select transistor which selects the circuit when programming, and a capacitor to store the required driver transistor gate voltage for the frame time. Often there will be additional select devices, other switch devices and possibly more than one drive device and/or capacitor. However the principle of the techniques we describe will also work for these variants.

The pixel circuit needs to store a drive level with relative stability for a full frame period. The drive level is typically determined via a programming current and some kind of switchable feedback, or via a programming voltage. However regardless of the method the result is a voltage on the gate of the drive transistor which is held using a capacitor. The size of the capacitor is determined by the total current leakage—which changes the stored voltage with time—and by the duration for which the voltage needs to be stored. Typically the dominating leakage path is through the select transistor.

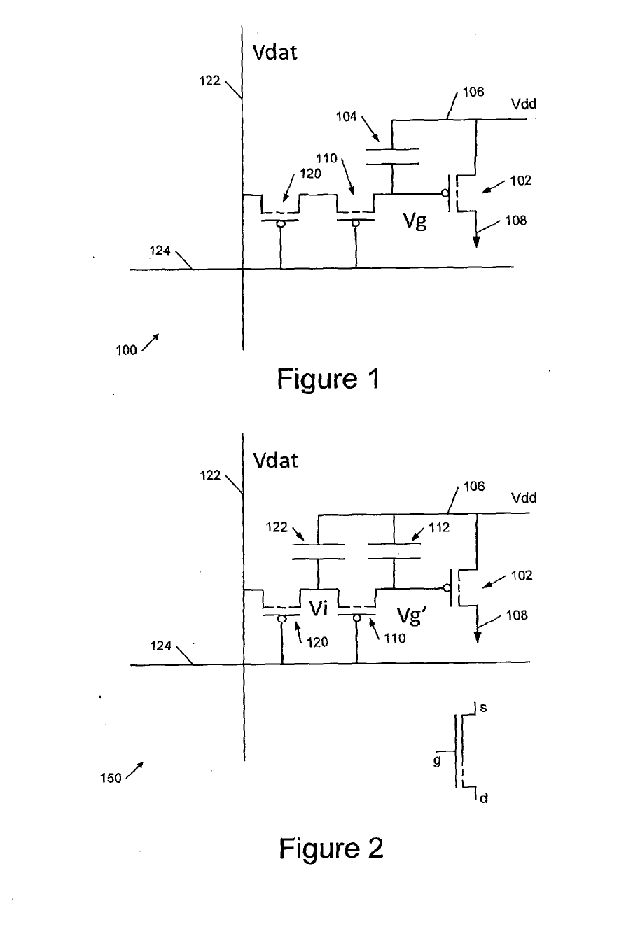

Referring now to FIG. 1, this shows an AMOLED pixel circuit 100 comprising an OLED drive transistor 102 having a gate connection coupled to a gate charge storage capacitor 104 storing a gate voltage V_{g}. Both the transistor 102 and gate capacitor 104 are coupled to a power supply (V_{DD}) line 106. A pair of select transistors 110, 120 are connected with their input/output connections in series between the gate of drive transistor 102 and a data line 122, here a voltage-programming data line to program directly voltage V_{g} on the gate of transistor 102. The gates of transistors 110, 120 are connected together to a pixel select line 124. Connection 108 of drive transistor 102 provides an OLED drive connection for driving an OLED pixel or sub-pixel (OLED not shown in FIG. 1).

The arrangement of FIG. 1 uses the series-connected select devices to reduce the leakage current, and hence reduce the size of storage capacitor 104. In broad terms, doubling up the select device enables the size of the storage capacitance 104 to be reduced by a factor of approximately two—the leakage current is effectively halved and thus for a given storage time the size of the capacitance may also be halved.

In broad terms the programming time τ_{pgm} of an active matrix pixel driver circuit is proportional to the capacitance C, to the resistance R though which the capacitance is charged, and to the change in voltage, ΔV imposed by programming of the pixel (whether voltage or current), and is inversely proportional to the programming current, I_{prog}, as follows:

$${τ}_{pgm} ∝ \frac{RC Δ V}{{I}_{prog}}$$

It can therefore be appreciated that the circuit of FIG. 1 does nothing to improve the programming time: Although the size of the storage capacitor 104 has halved, the RC time constant is substantially unchanged because the resistance through which the storage capacitor 104 is programmed has approximately doubled:

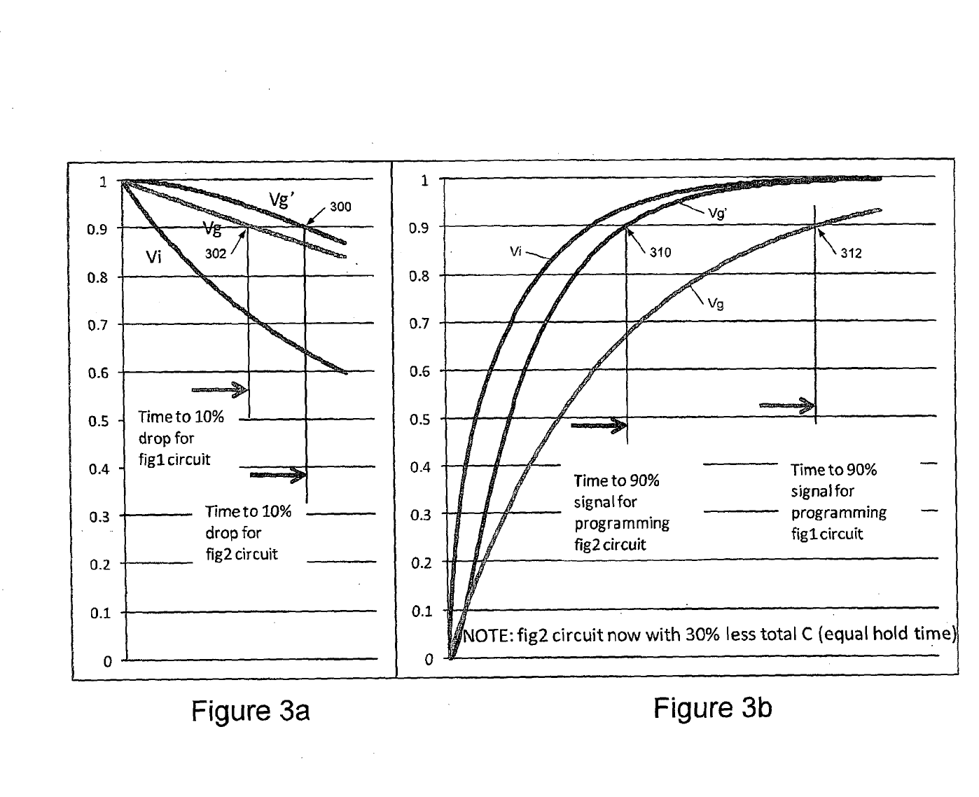

FIG. 2 shows an AMOLED pixel drive circuit 150 according to an embodiment of the invention. Like elements to those of FIG. 1 are indicated by like reference numerals. However in the circuit of FIG. 2 the storage capacitance 104 is split between a pair of capacitors, a gate capacitor 112 connected between the gate of transistor 102 and the V_{DD} line 106 and an additional input capacitor 122 connected to the series connection between transistors 110 and 120, and also connected to power supply line 106. In embodiments of the FIG. 2 arrangement there are the same number of switches as in FIG. 1, and in embodiments the total capacitance may be the same. However by cascading the capacitance the response of the circuit is modified in a non-intuitive manner.

First, for a given capacitance, the time for the gate voltage to drop to 10% of its original value is increased by ˜40%. Alternatively it is possible to reduce the total capacitor area to approximately 70% of that in the circuit shown in FIG. 1 while maintaining the same ability to hold the programmed voltage.

Further, this circuit also reduces the time for the circuit to settle to a new programmed voltage. These two factors do not normally scale together. However the circuit in FIG. 2 changes the profile of the gate voltage from an exponential tending towards Vdat to more of an ‘S’ shaped profile, reducing the initial slope up to the 10% point, but increasing the slope thereafter. If the capacitance is reduced to ˜70% of the previous circuit, the result is an approximate halving of the programming time, with a reduced circuit area, without compromising the hold-time to a 10% drop from the programmed level.

In broad terms, the effect of splitting the gate storage capacitance is that the voltage V_{g}’ on the gate capacitance ‘chases’ the voltage Vᵢ, on the input capacitor 122. Conceptually one might expect this to increase rather than to reduce the programming time but the overall effect, because the value of the gate capacitor 112 may be reduced, is to decrease the programming time.

Correspondingly, comparing the circuit of FIG. 2 with that of FIG. 1, in FIG. 1 the entire gate storage capacitance 104 has two select transistor resistances in series with this capacitance. One might expect that effectively reducing the leakage resistance for a part of the storage capacitance by locating the input capacitor 122 at a junction between the series-connected select transistors would reduce the overall hold time of the circuit. However, counter-intuitively, again this is not the case, in broad terms because the value of V_{g}’ chases' the value of Vᵢ down.

With regard to the hold operation of the pixel circuit of FIG. 2, the effect is to change the shape of the leakage decay curve so that the initial portion of the curve is flattened by comparison with that of FIG. 1. This is the important portion of the curve since flattening this portion, albeit at the expense of a faster later drop, increases the time for the stored gate voltage to drop to a threshold value, for example 90%, of its original level.

Referring next therefore to FIGS. 3a and 3b, these show the results of simulations of the circuits of FIGS. 1 and 2. FIG. 3a shows the decays of voltage values V_{g}, V_{g}’ and the Vᵢ of FIGS. 1 and 2 showing that although the Vᵢ falls faster than V_{g}, the gate voltage V_{g}’ of FIG. 2 falls slower than the gate voltage V_{g} of FIG. 1. Thus the point 300 in time at which voltage V_{g}’ falls to 90% of its original value is later than the point 302 in time at which V_{g falls to} 90% of its original value. It can also be seen that the shape of the decay curve is changed and in particular flattened for an initial time portion of the curve.

FIG. 3b shows corresponding curves for V_{g}, Vᵢ, V_{g}’ when programming the circuits of FIGS. 1 and 2. It can be seen that the point 310 in time at which V_{g}’ reaches 90% of a target value is earlier than a point 312 in time at which V_{g} reaches 90% of its target value. Thus by comparison with the circuit of FIG. 1, the pixel drive circuit 150 of FIG. 2 can be programmed faster and holds its data longer than the circuit of FIG. 1 and, as a corollary of this, for a given programming/hold time target the total area devoted to storage capacitance in the pixel drive circuit 150 of FIG. 2 may be reduced, in embodiments by 30-40%.

The precise shapes of the curves shown in FIG. 3 depend upon details of the simulated circuit, parasitic capacitances, leakage resistances and the like. Thus a determination of the relative values of the gate capacitor 112 and input capacitor 122 is best determined by experiment/simulation. Reducing the value of input capacitor 122 towards zero will tend to modify the behaviour of the circuit of FIG. 2 towards that of FIG. 1. By contrast, increasing the value of the input capacitor 122 away from an equal split of capacitance values will tend to reduce the programming time by reducing the net RC time constant for the storage capacitance. However with too little gate capacitance 112 the gate voltage is pulled up towards the source voltage and the drive transistor turns off. Nonetheless the leakage through and parasitic capacitance of the drive transistor 102 is relatively small compared with that of the select transistors 110, 120, and one effect of reducing the value of the gate capacitance 112 is to make the gate voltage more vulnerable to step changes in voltage during the programming process arising from charge injection via parasitic capacitance of the select transistors.

The rate of change of voltage on the gate capacitance 112 is determined by the voltage on the input capacitance 122. Thus making the input capacitance 122 larger and the gate capacitance 112 smaller than a 50:50 ratio will in theory tend to improve the programming/hold time of the pixel circuit 150, but in practice the results of simulating the circuit can be non-intuitive and thus a final determination of the relative values of these components is preferably made by simulating and testing an actual pixel circuit with which the technique is to be employed. Thus in an actual circuit the value of gate capacitor 112 may be less than, substantially equal to, or greater than that of input capacitance 122. In embodiments the gate storage capacitor 112 may be formed by an extension of the date-source overlap of derive transistor 102, as illustrated by the structure inset in FIG. 2.

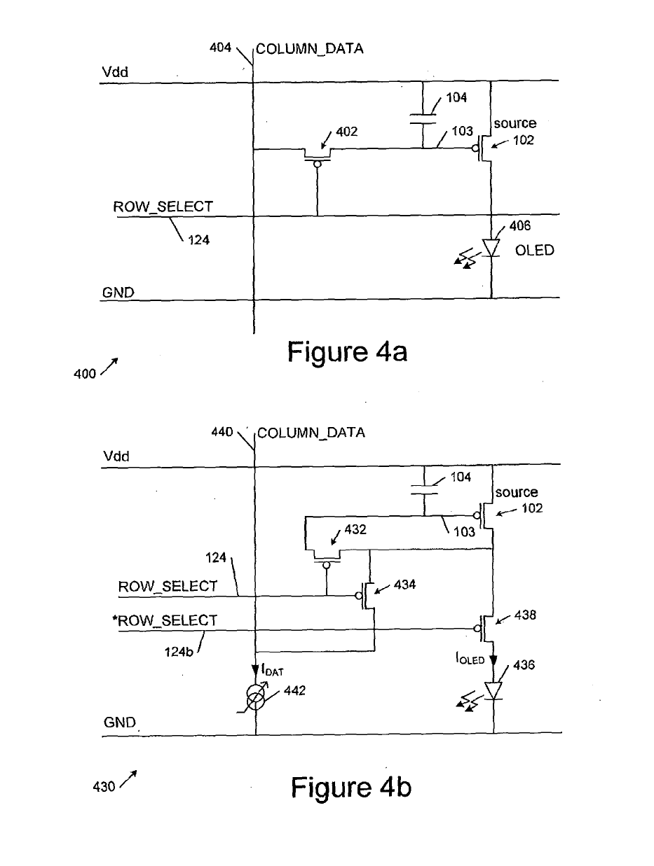

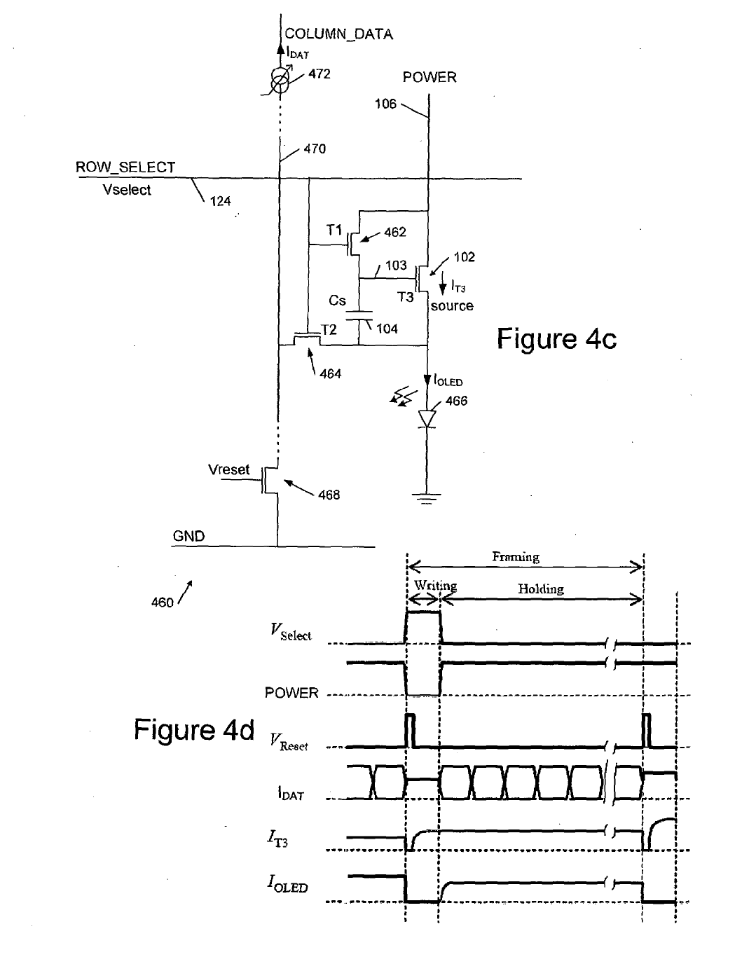

Referring now to FIGS. 4a and 4b, these show examples of pixel drive circuits incorporating storage in which the techniques we describe may be employed. These pixel driver circuits store the pixel data by, respectively, directly programming a gate voltage on the drive transistor, and by employing a current-copy technique in a current-program circuit. Like elements to those previously described are indicated by like reference numerals.

Thus in the voltage-programmed pixel circuit 400 of FIG. 4a a gate connection 103 of driver transistor 102 is coupled to a storage capacitor 104 and a select transistor 402 couples gate 103 to voltage-programming column data line 404 (similar to line 122 of FIG. 1), under control of row select line 124. When switch 402 is on a voltage on column data line 404 can be stored on a capacitor 104, and the voltage at gate node 103 controls the current through OLED 406 and hence the brightness of the OLED.

FIG. 4b (which is taken from our earlier patent application WO03/038790) shows an example of a “current copying” current-programmed pixel driver circuit 430. In this circuit the current through an OLED 436 is programmed by setting a drain-source current for OLED driver transistor 102 using a controllable current generator 442. Thus the brightness of OLED 436 is determined by the current, I_{DAT}, on the (column) data line 440 flowing into reference current generator 442, which is set for the pixel being addressed as desired. In operation the circuit copies and memorises the driver transistor gate voltage required for this drain-source current.

A switching transistor 438 is connected between drive transistor 102 and OLED 436 to inhibit OLED illumination during the programming phase. Select transistors 432 and 434 are coupled between column data line 440 and the gate connection 103 of driver transistor 102, operated by row select line 124. In the illustrated example circuit a corresponding inverted row select line 124b controls operation of a drive switch transistor 438.

To copy and store the programming current the drive switch transistor 438 is “opened” so that the programming current flows through drive transistor 102, and select transistors 432, 434 are switched on (the switches are “closed”) to set Vg on drive transistor 102 for the programmed current, and to store this Vg value on capacitor 104.

FIGS. 4c and 4d are taken from the IDW '04 paper and show a further example of a current programmed active matrix pixel circuit 460 in which the techniques we describe may be employed, and a corresponding timing diagram. These figures are adapted from the paper “Solution for Large-Area Full-Color OLED Television—Light Emitting Polymer and a-Si TFT Technologies” (Shirisaki et al, of Casio Computer Co Ltd and Kyushu University, Invited paper AMD3/OLED5 −1, 11^{th} International Display Workshops, 8-10 Dec. 2004, IDW '04 Conference Proceedings pp. 275-278, 2004). The brightness of OLED 466 is determined by the current, I_{DAT}, on (column) data line 470 flowing into reference current generator 472.

Again storage capacitor Cs 104 is connected between the gate and the source of the driver transistor T1 104, but in this example circuit the source of drive transistor 104 provides an OLED drive connection to OLED 466. Thus one plate of capacitor 104 is connected to gate 103 of drive transistor 104 and a second plate of capacitor 104 is connected to the OLED drive connection. A first select transistor T1 462 selectively connects the gate 103 of drive transistor T3 to a power supply line (Power) 106 and a further select transistor T2 464 selectively connects the gate 103 of drive transistor T3 to data line 470. A reset transistor 464 is provided to selectively ground data line 470.

In operation, in a first stage column data line 470 is briefly grounded to discharge Cs 104 and the junction capacitance of the OLED (Vselect, Vreset high; Power low). Then a data current I_{DAT} is applied so that a corresponding current flows through T3, and Cs stores the gate voltage required for this current (Power is low so that no current flows through the OLED, and T1 is on so T3 is diode connected). Finally the select line is de-asserted and Power is taken high so that the programmed current (as determined by the gate voltage stored on Cs) flows through the OLED (I_{OLED}).

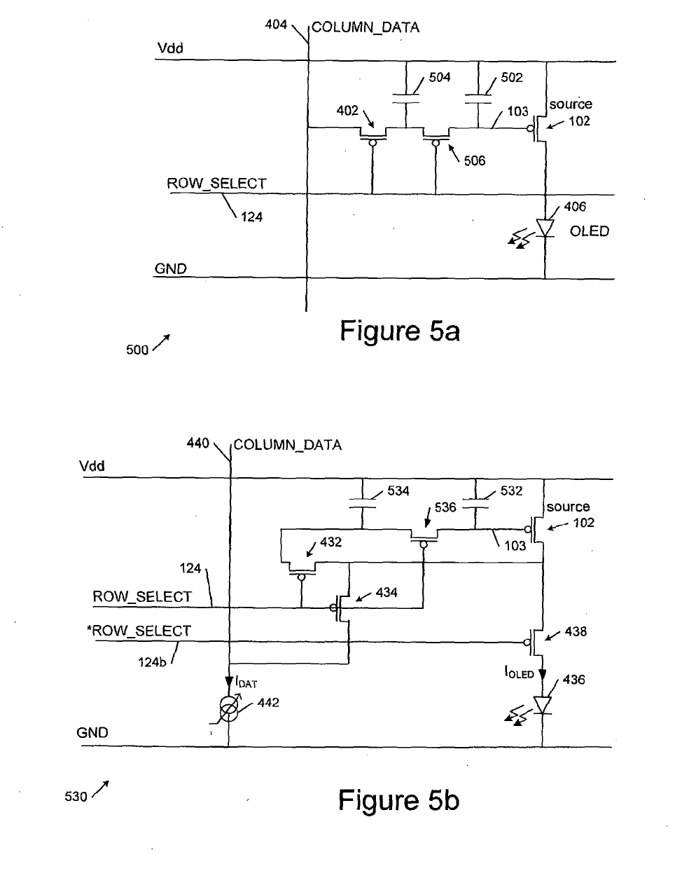

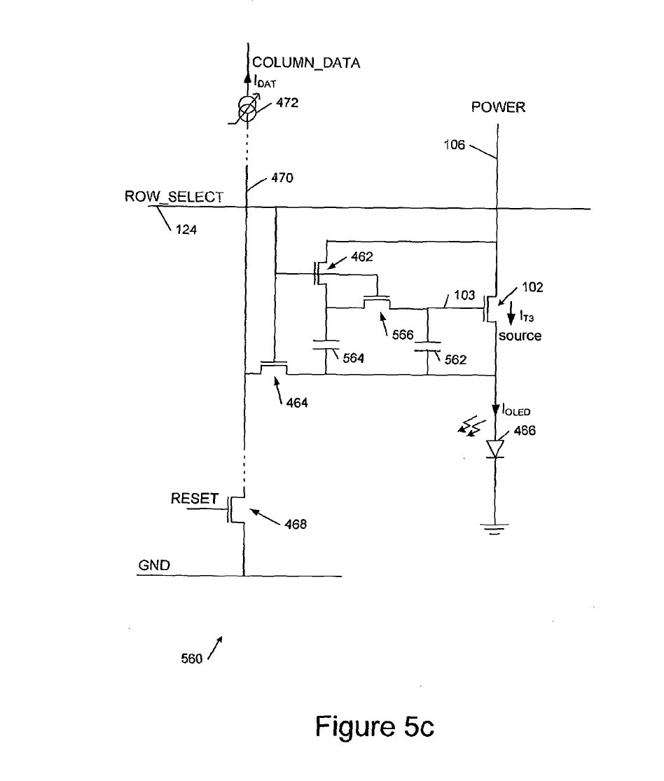

Referring now to FIGS. 5a and 5b, these show pixel drive circuits 500, 530 based upon those of FIGS. 4a and 4b, modified to implement the techniques we have described. In each case, like elements are indicated by like reference numerals.

Thus in FIG. 5a the pixel drive circuit 500 as a gate capacitor 502 programmed via an additional select transistor 506 having an input coupled to input capacitor 504. Thus the pixel driver circuit 500 of FIG. 5a has two select transistor-storage capacitor stages coupled in series, comprising transistor 402 and capacitor 504, and transistor 506 and capacitor 504, respectively. The select transistors 402, 506 are each coupled to the pixel drive circuit select line 124.

The pixel driver circuit 530 of FIG. 5b likewise has a gate capacitor 532 connected via an additional select transistor 536 to an input capacitor 534. Thus, again, the circuit 530 of FIG. 5b comprises a pair of series-coupled select transistor-storage capacitor stages, comprising transistor 532 and capacitor 534, and transistor 536 and capacitor 532, respectively. The select transistors 432, 536 (and transistor 434) are coupled to the pixel driver circuit select line 124.

FIG. 5c shows a pixel driver circuit 560 which is a modified version of the circuit 460 or FIG. 4c, implementing the cascaded capacitor techniques we describe. The arrangement of FIG. 5c is a little different to those of FIGS. 5a and 5b but again the circuit comprises a gate capacitor 562, an input capacitor 564, and an additional select transistor 566 series coupled between these two capacitors and having a control input coupled to the select line 124. The common connection of capacitors 562, 564 is connected to the OLED drive connection rather than to a power supply line. Nonetheless, similarly to the arrangements described above, the circuit of FIG. 5c comprises a pair of series coupled select transistor-storage capacitor circuit sections or stages, in the example of FIG. 5c, comprising transistor 462 and capacitor 564, and transistor 566 and capacitor 562 respectively. In the circuit of FIG. 5c a further select transistor 464 programs the circuit by selectively coupling the common capacitor connection of capacitors of 562 and 564 to the column data line 470, select transistor 462 operating to diode-connect drive transistor 102 during programming.

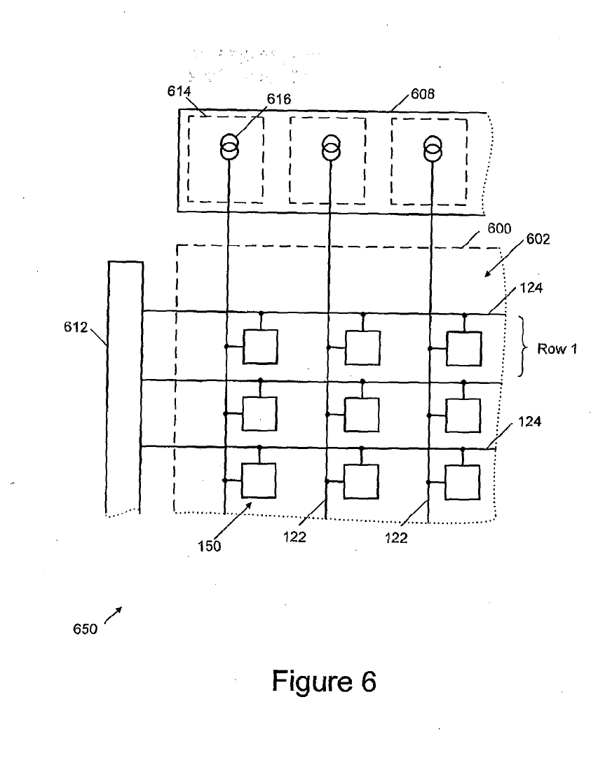

FIG. 6 shows an active matrix OLED display system 650 comprising an AMOLED display 600 on a glass panel 602, the display comprising an M row by N column array of voltage or current programmed active matrix pixel circuits 150 according to an embodiment of the invention. For clarity, only nine pixel circuits are shown, though the structure and operating principle of display 600 can be readily ascertained. Each active matrix pixel circuit 150 may comprise a circuit similar to that described above with reference to FIGS. 2 and 5a-5c for example, though any suitable active matrix pixel circuit could be implemented alternatively. Each active matrix pixel is connected to a column (data) line 122, 404, 440, 470 driven by column driver 608, and a row (select) line 124 driven by row driver 612. Here, the column driver 608 includes column control circuitry 614 including a controllable current source 616 for each column.

In embodiments of the above described circuits the gate capacitor generally has one plate formed in the gate metal layer, but since this capacitor connects to a source/drain connection of a select transistor, there will generally be a via connection between the source/drain metal layer and the gate metal layer for this capacitor. In a similar manner the input capacitor will generally also have a via connection to the source/drain metal layer of a select transistor, and thus embodiments of the above described pixel driver circuits may employ an extra via by comparison with a circuit having a single gate capacitor. Nonetheless there is still an overall benefit provided that the size of a via is less than the reduction in storage capacitor area, and this is generally the case. In principle the above described circuits could be extended to three or more cascaded select transistor-storage capacitor stages, but in practice there are likely to be diminishing returns from such implementations.

Broadly speaking, we have described splitting the pixel capacitance using a secondary select switch, to both reduce the storage capacitor size and to reduce the programming signal level settle time when programming. The general principle of splitting the capacitance into two (or potentially further) and the inclusion of an additional select device between the two capacitances can, potentially, be applied to any AMOLED pixel driver circuit, to both reduce settling time and to reduce the size of storage capacitor used to maintain OLED current in the presence of switch transistor leakage.

No doubt many other effective alternatives will occur to the skilled person. It will be understood that the invention is not limited to the described embodiments and encompasses modifications apparent to those skilled in the art lying within the spirit and scope of the claims appended hereto.

1. An active matrix OLED pixel driver circuit, the circuit comprising:
a power supply connection to receive a power supply;
an OLED drive connection to drive an OLED;
an OLED drive transistor having an input, output and control connection, wherein said input connection is coupled to said power supply connection and said output connection is coupled to said OLED drive connection;
a gate capacitor having a first plate coupled to said control connection of said OLED drive transistor and a second plate coupled to a common capacitor connection;
a first select transistor having an input connection, an output connection coupled to said first plate of said gate capacitor, and a control connection coupled to a first pixel select connection of said OLED pixel driver circuit;
an input capacitor having a first plate coupled to said input connection of said first select transistor and a second plate coupled to said common capacitor connection; and
a second select transistor having an input connection, an output connection coupled to said first plate of said input capacitor, and a control connection coupled to a second pixel select connection of said OLED pixel driver circuit.

2. An active matrix OLED pixel driver circuit as claimed in claim 1 wherein said first and second pixel select connections comprise connections to a shared pixel select connection of said OLED pixel driver circuit.

3. An active matrix OLED pixel driver circuit as claimed in claim 1 wherein said input connection of said second select transistor is coupled to a voltage or current programming connection of said OLED pixel driver circuit.

4. An active matrix OLED pixel driver circuit as claimed in claim 3 wherein said input connection of said second select transistor is coupled to said voltage or current programming connection of said OLED pixel driver circuit via a further select transistor.

5. An active matrix OLED pixel driver circuit as claimed in claim 1 wherein said common capacitor connection is coupled to said power supply connection of said OLED pixel driver circuit.

6. An active matrix OLED pixel driver circuit as claimed in claim 1 further comprising a third select transistor having an input connection coupled to a current programming connection of said OLED pixel driver circuit, an output connection coupled to said common capacitor connection, and a control connection coupled to a third pixel select connection of said OLED pixel driver circuit, and wherein said input connection of said second select transistor is coupled to said power supply connection of said OLED pixel driver circuit.

7. An active matrix OLED pixel driver circuit as claimed in claim 6 wherein said common capacitor connection is coupled to said OLED drive connection.

8. An active matrix OLED pixel driver circuit as claimed in claim 6 wherein said first, second and third select connections comprise connections to a shared pixel select connection of said OLED pixel driver circuit.

9. An active matrix OLED pixel driver circuit as claimed in claim 1 wherein said common capacitor connection is coupled to a source connection of said OLED drive transistor.

10. An active matrix OLED pixel driver circuit as claimed in claim 1 wherein said gate capacitor and said input capacitor have substantially the same capacitance value.

11. An active matrix OLED pixel driver circuit as claimed in claim 1 wherein a capacitance of said input capacitor is larger than a capacitance of said gate capacitor.

12. An active matrix OLED pixel driver circuit as claimed in claim 1 wherein said gate capacitor is integrated with said OLED drive transistor.

13. An active matrix OLED pixel driver circuit as claimed in claim 1 further comprising:
a further select transistor coupled between said output connection of said second select transistor and said input connection of said first select transistor, and having a control connection coupled to a further pixel select connection of said OLED pixel driver circuit; and
a further capacitor coupled between said input connection of said select transistor and said common capacitor connection.

14. An active matrix OLED display comprising an array of active matrix OLED pixel driver circuits each as recited in claim 1.

15. A method of driving a pixel of an active matrix OLED display, using a pixel driver circuit comprising:
a power supply connection to receive a power supply;
an OLED drive connection to drive an OLED; and
an OLED drive transistor having an input, output and control connection, wherein said input connection is coupled to said power supply connection and said output connection is coupled to said OLED drive connection;
the method comprising:
programming a control voltage on said control connection of said OLED drive transistor via a chain of transistor-capacitor circuit sections, each said circuit section comprising a select transistor having an output coupled to a capacitor, a final said select transistor of said chain having said output of said select transistor coupled to said control connection of said OLED drive transistor, each of said select transistors having a control connection coupled to a pixel select line of said display and each capacitor of said chain having one plate coupled to a common capacitor connection for said chain;
said programming comprising:
controlling each of said select transistors to switch on to charge each of said capacitors responsive to a programming signal applied to said chain of transistor-capacitor circuit sections, to charge a final capacitor of said chain to apply said control voltage to said OLED drive transistor; and
controlling all of said select transistors to switch off to maintain said control voltage on said control connection of said OLED drive transistor.

16. An active matrix OLED pixel driver circuit, the circuit comprising:
a power supply connection to receive a power supply;
an OLED drive connection to drive an OLED;
an OLED drive transistor having an input, output and control connection, wherein said input connection is coupled to said power supply connection and said output connection is coupled to said OLED drive connection; and
a programming circuit for programming a control voltage on said control connection of said OLED drive transistor, said programming circuit comprising a chain of transistor-capacitor circuit sections, each said circuit section comprising a select transistor having an output coupled to a capacitor, a final said select transistor of said chain having said output of said select transistor coupled to said control connection of said OLED drive transistor, each of said select transistors having a control connection coupled to a pixel select line of said display and each capacitor of said chain having one plate coupled to a common capacitor connection for said chain.

17. An active matrix OLED display comprising an array of active matrix OLED pixel driver circuits each as recited in claim 16.
